(19) United States
(12) Patent Application Publication
(10) Pub. No.: US 2006/0112898 A1
(43) Pub. Date: Jun. 1, 2006

(54) Animal entertainment training and food delivery system

(76) Inventors: Michael Maurice Fjelstad, Scotts Valley, CA (US); Kenneth C. Miller, Aptos, CA (US)

Correspondence Address: Walt Froloff, 273D Searidge Rd, Aptos, CA, 95003, US

(21) Appl. No.: 11/291,059

(22) Filed: Nov. 30, 2005

Related U.S. Application Data
(60) Provisional application No. 60/632,049, filed on Dec. 1, 2004.

(51) Int. Cl. A01K 1/03

(52) U.S. Cl. 119/496

(57) ABSTRACT

Disclosed is an interactive pet toy, food delivery and training system with toy object which moves furtively in and out of a recess of an assembly and which when captured provides the pet an edible treat. The furtive toy object can be manipulated manually, remotely or automatically.

### CROSS-REFERENCES TO RELATED APPLICATIONS

This application is a Non-Provisional based on Provisional Patent Application No. 60/632,049 filed on Dec. 1, 2004.

### FIELD OF THE INVENTION

This invention relates to the field of care for animals and in particular to entertain, train and provide food for pets by manual remote, automatic and programmed mode

### BACKGROUND

Numerous disparate types of toys have been created to provide entertainment both for animals and their owners or keepers. It is also of value to have a toy which will capture the attention of the animal in order to keep the animal from engaging in potential destructive mischief. Toys developed for animals take many forms and they exist in all shapes and sizes. A recurring deficiency of traditional designs is that they lack sufficient realism and reward to maintain the animal's interest for extended periods. Over time the animal will become inured to the toy and loose interest. The animal may play with the toy for a while, but then become bored due to the predictable nature of many toys.

U.S. Pat. No. 5,651,332, Interactive pet device, teaches a pet toy footstool comprised of a electrically animated mouse like creature suspended inside a simulated mouse hole, a replaceable drape curtain, an interior access sanctuary for the cat and a stool footrest for the owner. The device electrically animates the mouse in a random life like manner from virtually any location and may be operated by a remote control. This device is limited by the suspension of a mouse object for the sole entertainment and amusement of a cat. Cats have many personalities and modes, a suspended mouse object even twitching a random intervals, may not entice, entertain, or train a cat. Although the shelter makes for a nice foot stool, the electrically animated suspended mouse object may not sufficiently keep a cat enticed. Thus although other pets and animals appear to be discriminated against by this invention, there is a need to accommodate a cats personality and mood, which changes frequently, and the random electronic dangling of a mouse object leaves many cats out.

U.S. Pat. No. 6,571,742, Interactive pet toy, discloses an interactive toy for use with pets and includes a housing having a toy-like object positioned within the housing. The toy-like object is connected to a mechanical locomotion means so that the object can be selectively extended out of the housing and retracted back into the housing. The locomotion means effectuates extension of an object outside the housing and effectuates retraction of object into the housing, a support carriage, said support carriage comprising an external and internal bellows. This is rather mechanically complicated device requires manual manipulation; so said pet is totally dependent on a human operator to play with, invalidating the need for this invention in many situations. '742 discloses a sound device which emits a prerecorded sound in response to movement, propulsion or retraction of the pet amusement object. '742 also discloses a light/motion sensor sensitive to motion or light that is electrically connected to a motor and thus a response. The connection is limited electrically and the sensor is fixed at some location near the mouse object. This is very inconvenient and unaccommodating, as pet enticement should occur well in advance of the necessity for pet proximity, else the mechanism may never engage. Also inconvenient is the necessity for a electrical connection. What is needed is the more convenient way to track the pets location, so that a programmed response is more likely to get the attention and entice fido into the prey objects proximity. '742 lacks programmability and demands the pets proximity to the prey enclosure to engage any action. The introduction of sound helps little if the prerecorded sound used is of no interest to the animal. A pet is enticed better by audio outside of our hearing range AND would rarely respond to the pre-recorded sound. Moreover, the air sound rushing in and out of the bellows mechanism would only confuse the pet with any pre-recorded sounds. What is needed is audio to entice the pet, even if that pets audio enticement range is outside the human hearing range.

U.S. Pat. No. 6,568,353, Play house for cats, provides a container with numerous perforations and an interior containing various mouse and other cat toys which may be accessed through the perforations by a cat's arm. The mouse toys may include a figure atop a moveable spring, a removable mouse, one or mice on a turntable, musical and sound mice, etc. Other cat toys can include balls which rattle when moved, and toys which can emit a variety of sounds based on a battery powered sound chip. The '353 playhouse can purportedly be used to evaluate feline aggressiveness, docility and other traits for breeding and feeding, for psychological purposes, for exercise, for coordination, to relieve boredom. However, any evaluation of cat behavior is subjective, as aggressive and docile traits would be dependant on the extent of enticement and stimulation of pet interest. '353 provides no food or shelter for the pet, and is solely for the entertainment of a cat through mechanical device. What is needed are pet care systems which include food and shelter. What are needed are more general devices and not only for cats, but dogs and small pets, to entertain and respond more individually and truly interact with the pet, instead of a beacon to the pet in the hopes that it will respond. What is needed are less limiting methods to attract the pets attention, to respond to pets individual behavior.

U.S. Pat. No. 5,657,721, Cat exercise toy, discloses local and remote motion detectors which sense the presence or movement of a cat in an area near a toy and in an area remote from the toy. In response to the motion detectors, an electric motor moves a target to attract the cat. '721 device disconnects the target from the electric motor, when the cat subdues the target, allowing the target to stop moving while being held by the cat and giving the cat an artificial sense of “post-kill” satisfaction, while simultaneously prolonging the component life of the toy. The sensing means in '721 is limited to motion detection by infrared pyrometers, photodiodes, phototransistors, silicon pn-junction detectors, silicon PIN diodes, GaA diffusion detectors, GaA Schottky type detectors, GaP photodiodes, and CCD detector arrays. These do not include locating a pet by simple wireless positional location, RFID or GPS. A wireless locator also has the advantage of economics, being much less costly to purchase and install into a pet care system. Moreover, '721 appears to center on enticing through object movement and ignores use of olfactory or food enticement mechanisms. Also, only cats are addressed, discriminating or at least ignoring dogs and other pets.

Cats and dogs have exhibited interest in furtive movement of smaller creatures such as squirrels and mice as they are natural prey for them. The animal enjoys both the pursuit of the prey and its capture. Unfortunately, in the case of most interactive toys at least for cats, the capture is quick and the apparent sense of reward is fleeting. Furthermore, most facilities are limited to a particular kind of pet, be it a cat, dog, chipmunk, pet rat, rabbit. However, most animals will respond to artificial creatures that look, smell or sound like what their instincts would call potential food. What is needed is interactive devices adaptable for a diversity of kinds of pets.

Animals have deeply imbedded instincts for survival. While domestication has valid strong points, animals still have needs to stalk, hunt, be occupied and function in certain capacities, cats to hunt rodents and dogs investigate and alert us to danger. These instinctual characteristics of pets can be revived and enhanced to make happier pets, with some care and training. This training is usually too much work for the average owner. Hence there is a need to retrain animals to sharpen their instinctual skills while providing some entertainment and care.

While balls and other common objects can capture the attention of animals and both dogs and cats can and do play with them, they require constant interaction between the animal and a human. Small graspable toys are ideal for both cats and dogs but they should ideally be sized to the animal. In play or actual hunting, cats tend to grasp first with their claws, while dogs tend to use their mouths almost exclusively for capturing the item of their interest and attention. It is thus important to have a toy which can serve the interests of both types of animals providing a realistic relation to the animal's natural interests and instincts. Ideally such toys will produce an enduring attraction so that the animal continues to hold interest. Animals quickly grow bored of known activity and events. However, pets need entertainment and stimulation, and with the advent of programmable computer technology, animal characteristics, personalities, moods and behavior can be accommodated with some variability in the entertainment, training or food delivery which is responsive to as well as program directed. Current products include some mechanical contrivances, which allow a mechanical decoy to act as a prey or play objects. These are unsophisticated, acting as dumb objects, which dangle at random, or spin on trays in predictable ways to attract the attention of an animal. These current devices are not responsive to the animal and provide limited entertainment. They have no programmable features that can entice, train or keep an animals interest. Furthermore, they do not deliver food to the animal in any meaningful way to train or care for the animal. There is need for devices for the entertainment of pet animals, food delivery systems responsive to and in conjunction with training.

### BRIEF DESCRIPTION OF THE DRAWINGS

FIG. 1 provides top, side and front views of one embodiment of an interactive pet toy food delivery and shelter according to the present invention.

FIG. 2 provides top, side and front views of a base of the present invention containing a furtive toy and a mechanism for its deployment.

FIG. 3 is a perspective view of the housing base shown in FIG. 2 with a lid removed.

FIG. 4 is an exploded perspective view of the mechanism of the base shown in FIGS. 2 and 3.

FIG. 5 is an exploded perspective view of one embodiment of a shelter portion of the present invention.

FIG. 6 is an exploded perspective view of another embodiment of the shelter portion of the present invention.

FIG. 7 is an exploded perspective view of a third embodiment of the shelter portion of the present invention.

FIG. 8 provides several views of a mouse assembly for the present invention.

FIG. 9 provides several views of the base of the present invention and its mechanisms.

FIG. 10 includes top, side, front, and perspective views of the base of the present invention.

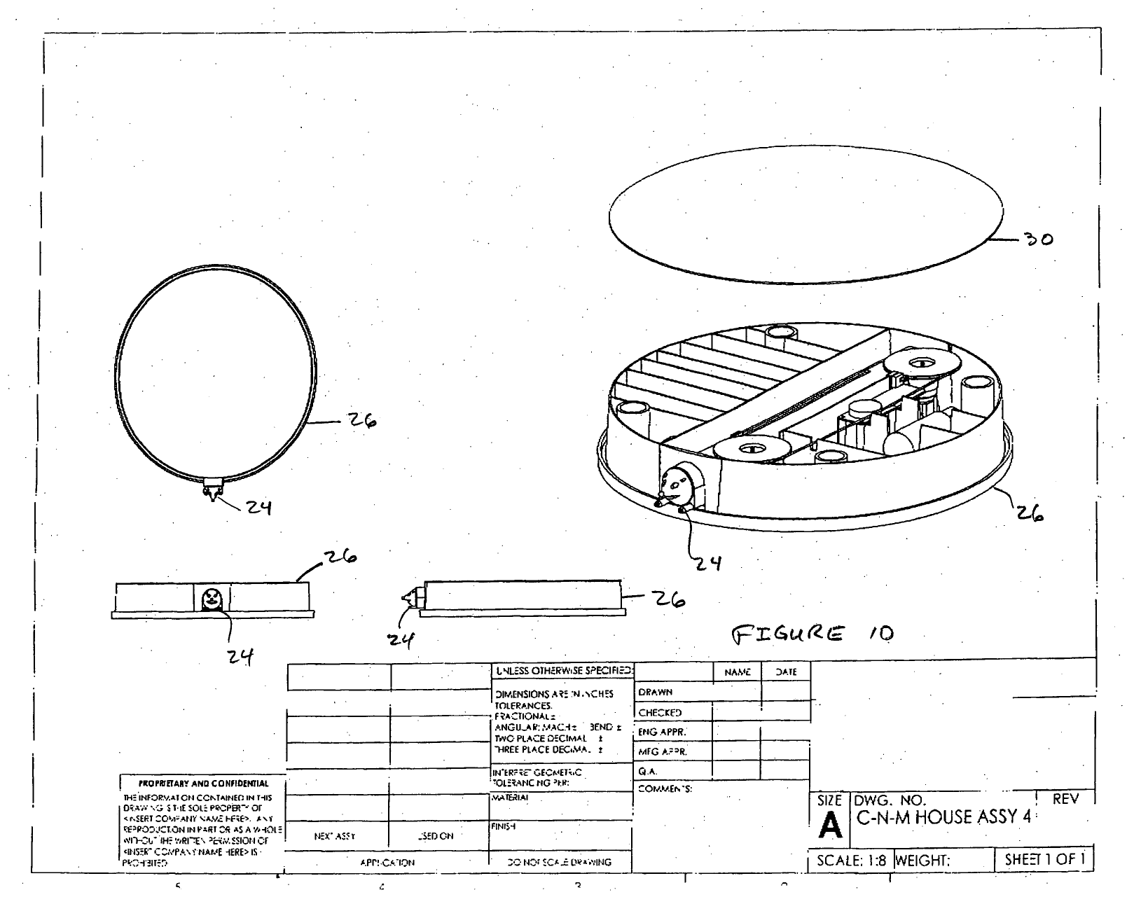

FIG. 11 is a sectional view and a front view of another embodiment of the present invention.

FIG. 12 is a sectional view and a front view of yet another embodiment of the present invention.

FIG. 13 is a sectional view and a front view of an additional embodiment of the present invention.

FIG. 14 is a sectional view and a front view of another embodiment of the present invention.

FIG. 15 is a perspective view of a preferred embodiment of an interactive pet toy, food delivery and shelter according to the present invention.

FIG. 16 is a perspective view of an interactive pet toy prey object assembly drawing according an embodiment of the present invention.

FIG. 17 is a side view of an interactive pet toy prey object assembly with food feeder and delivery mechanism according an embodiment of the present invention.

FIG. 18 is a perspective view of an interactive pet structure with feed hopper according an embodiment of the present invention.

FIG. 19 is a perspective view of the PCB and electronics assembly according an embodiment of the present invention.

FIG. 20 illustrates a high level cycle of operation for the electronic programmable automation of feeding and training for a selected animal in accordance with an embodiment of the present invention.

FIG. 21 illustrates a high level cycle of operation for the programmed automatic feeding of a selected animal in accordance with an embodiment of the present invention.

FIG. 22 illustrates a high level cycle of operation for the programmed automatic training of a selected animal in accordance with an embodiment of the present invention.

FIG. 23 is a perspective view of a preferred embodiment of an interactive pet toy, food delivery and shelter illustrating the portability features in accordance with an embodiment of the present invention.

### SUMMARY

Disclosed is a combined animal entertainment, food delivery and training system comprising a housing with one or more artificial prey objects capable of extending out from, and retracting into the housing, a means to mechanically manipulate the prey object extension and retraction, and a means to dispense food coupled to the prey object wherein food is dispensed when the prey object is exposed and reloaded when prey object is retracted. This whereby an animal can be entertained or trained through the use of an artificial prey object coupled with food dispensation either manually or programmably. This further includes an electrical power source and electro-mechanical means to manipulate the prey object remotely and electronic wireless signal means to locate a selected animal carrying a mounted wireless sensor device.

### DETAILED DESCRIPTION

The invention is designed to accomplish several objectives, which combined, fulfill the need for novel pet toy food delivery system which can entertain and reward a pet for successfully engaging in play with the pet toy. It is thus a first object of the invention to provide a pet toy which moves in a furtive manner, without direct initial stimulation by the animal, so as to capture the attention and interest of the animal so that it engages in play with the device. It is a second object is to provide a pet toy that will move furtively with or without participation on the part of a human. A third object is to provide a pet toy food delivery SYSTEM which activates automatically by means of sensors in response to physical movement of persons or things proximate to the toy object, which may be food. A fourth objective is to provide a pet toy food delivery SYSTEM that can be operated manually if desired. A fifth objective is to provide a pet toy and food delivery SYSTEM, which will provide an edible or sense stimulating, such as smell, reward for the animal when it successfully captures the object. A sixth object is to provide a pet toy and food delivery SYSTEM which is capable of self reloading rewards when one such is taken so that the animal can return to the toy with a sense that there will be another reward with each capture. A seventh objective is to provide a pet toy and food delivery SYSTEM that can serve also as a place wherein the animal can sleep when it tires. An eighth objective of the invention is to provide a toy that can be easily assembled and disassembled when desired for movement or storage. A ninth objective of the invention is to provide a surface upon which pets can scratch and stretch.

The drawings depict various preferred embodiments of the present invention for purposes of illustration only. One skilled in the art will readily recognize from the following discussion that alternative embodiments of the structures and methods illustrated herein may be employed without departing from the principles of the invention described herein. In the drawings, where applicable, the same reference numbers may identify identical or substantially similar elements or functions. Any modifications necessary to the Figures can be readily made by one skilled in the art based on the detailed description provided herein.

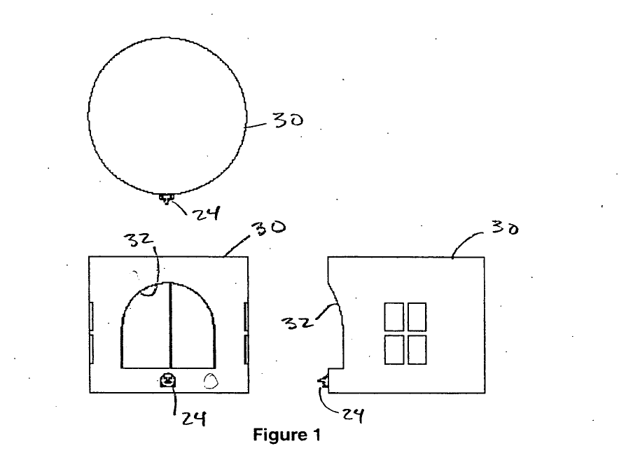

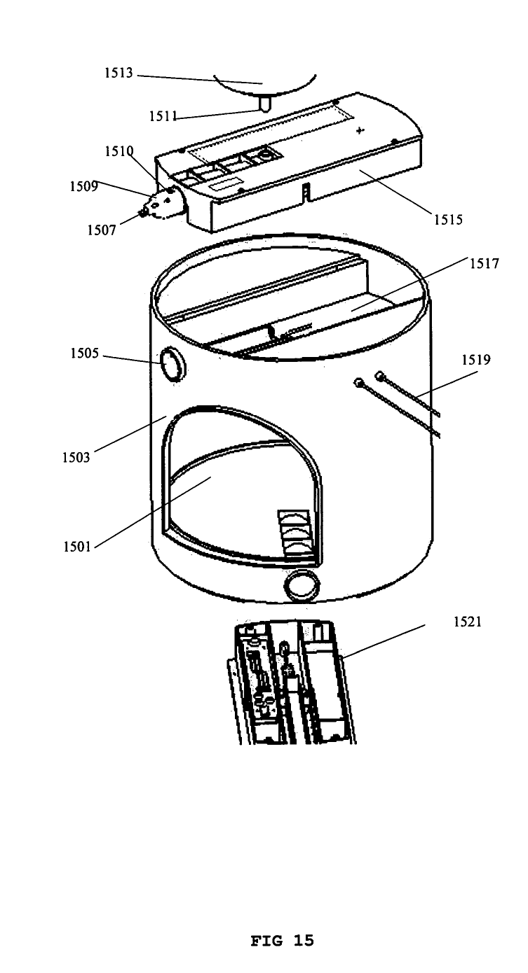

FIGS. 1 and 15 show overall views of one embodiment of an interactive toy and shelter 30 of the present invention with a target prey 24 partially exposed. The target prey 24 can be made to appear as a small animal, such as a mouse, but it is not so restricted. The target prey can be made from a hard or soft material in accordance with the desires of the user. The target prey can be attached so that it can be removed by the animal with a chosen degree of difficulty according to the desires of the user or as the animal's proficiency and success rate increases. All or a portion of the target prey can be made of an edible or olfactory sense provoking material according to the desires by the user. The enclosed housing of the interactive toy and shelter 30 has an opening 32 large enough for a pet cat or small dog to enter. The enclosed housing is large enough for a cat or small dog to lie down in. The enclosed housing may be covered with a removable or replaceable scratch pad.

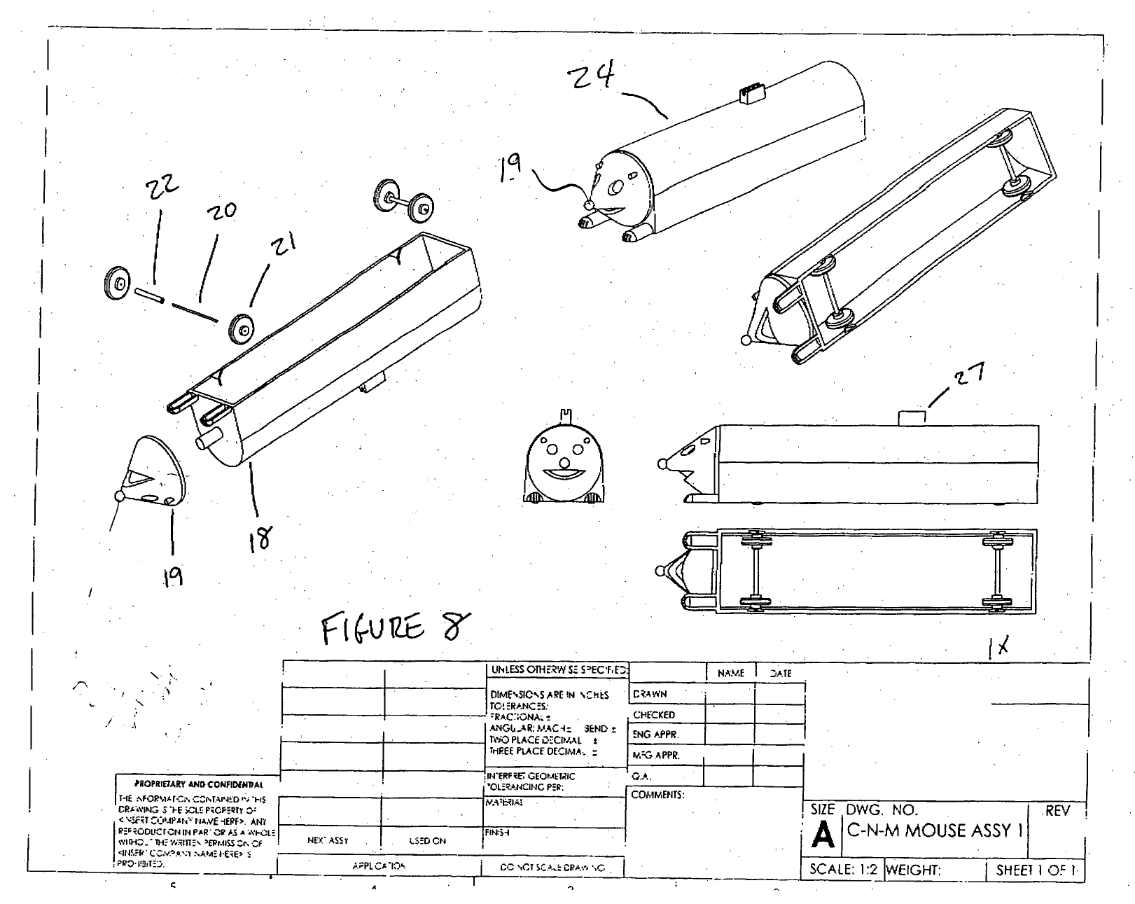

The preferred embodiment of the present invention is a pet toy with a movable furtive prey capable of extending out of, and retracting into a housing. Shown in FIG. 1 are top, front and side views of the toy with the furtive prey 24 partially extended out of the housing. The movable furtive prey can be retracted far enough into the housing so that a pet cannot reach it. The furtive prey can have features which are removable and edible by the pet such as the mouse head 19 shown in FIG. 8.

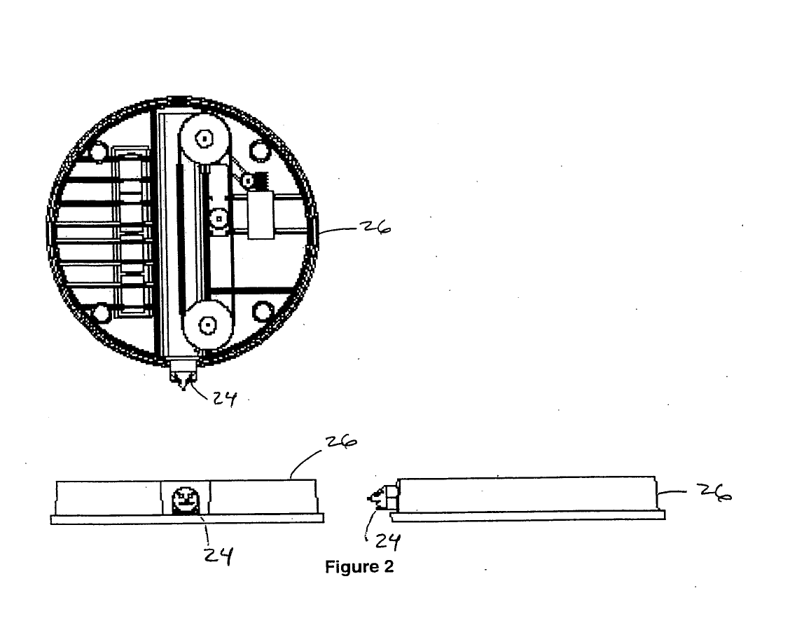

FIG. 2 provides top, side and front views of a base 26 of the interactive toy and shelter 30, which holds a mechanism that operates the target prey 24. While the term base has been used to describe the structure, it is not as limited as it could be placed on the top of the structure if desired to make jumping a part of the pet's activities in pursuit of the target prey.

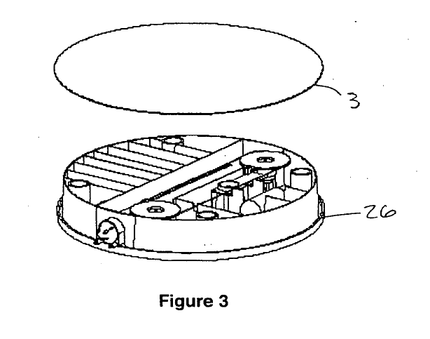

FIG. 3 provides a perspective view of the base 26 with a cover 3 removed. This could be the entire toy, without the upper “pet” house structure.

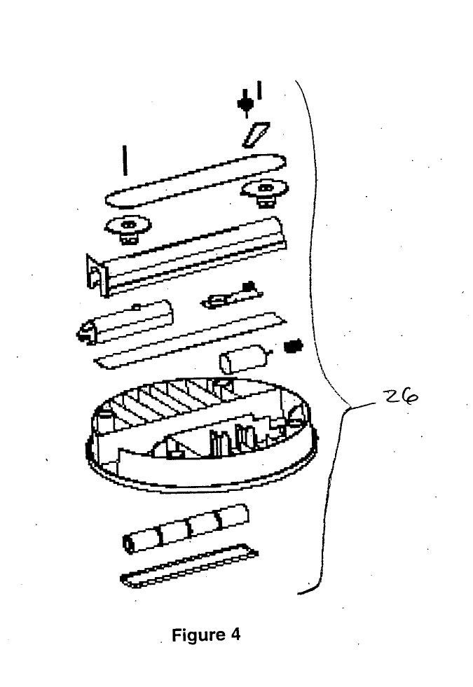

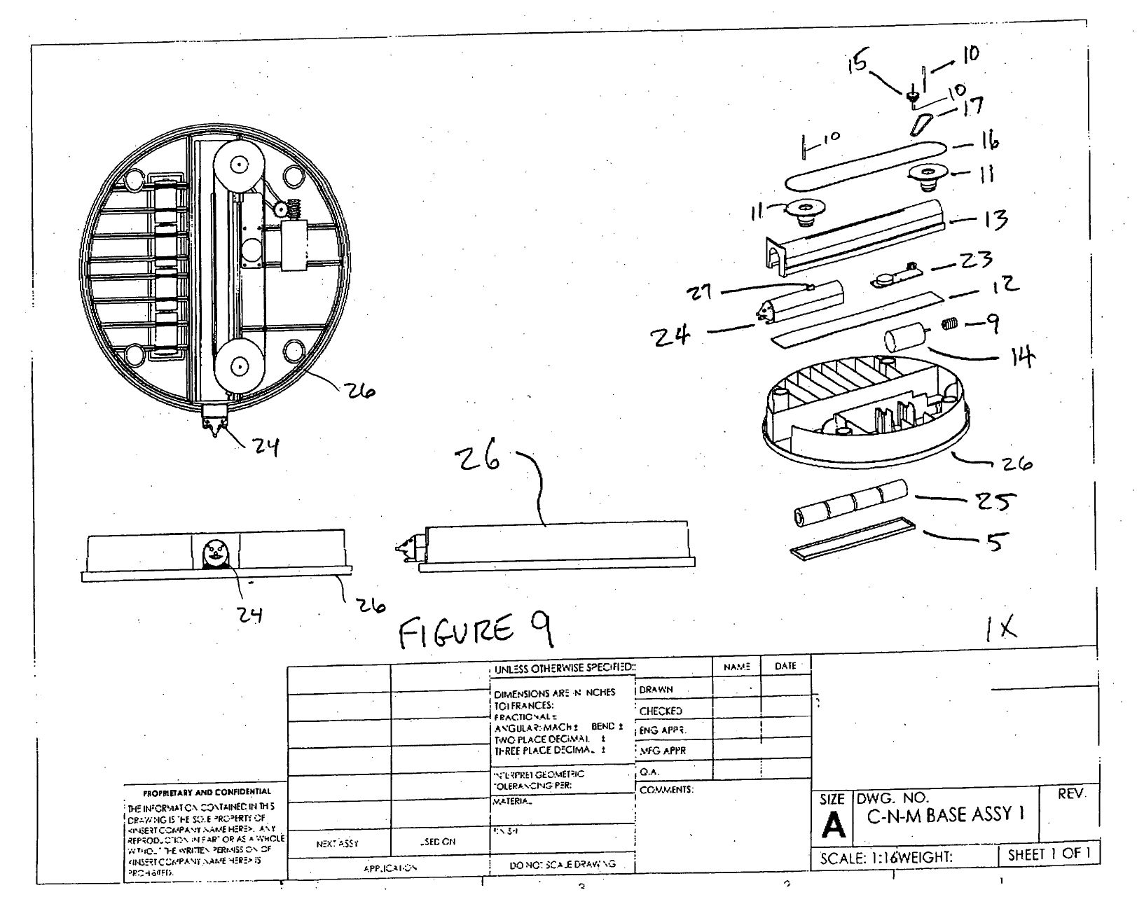

FIG. 4 provides an exploded perspective view of the components of the base 26. These components are explained in greater detail below with respect to FIG. 9.

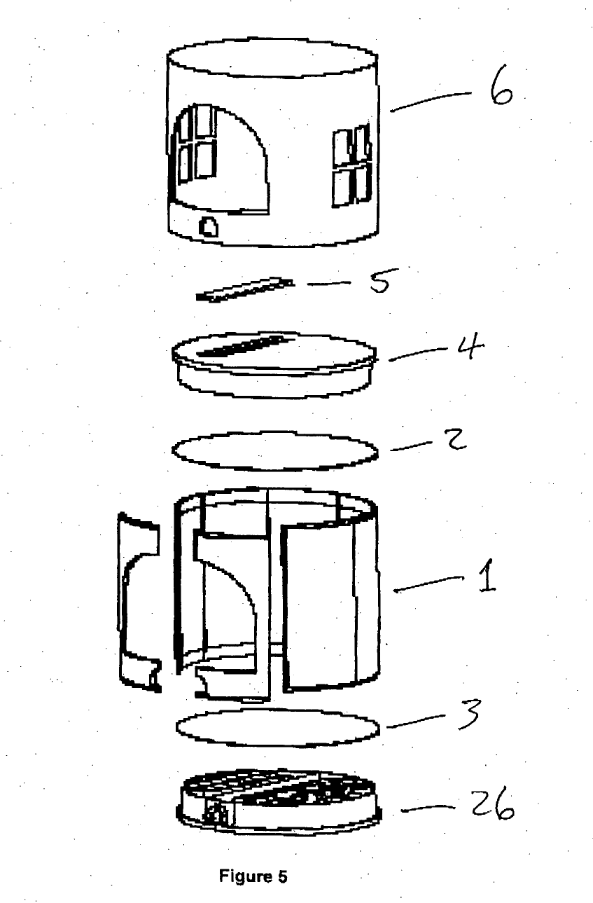

FIG. 5 provides an exploded view of the elements of construction of one embodiment of the interactive toy and shelter 30. Base 26 contains the target prey 24 and a mechanism that extends the prey out of the housing and retracts it into the housing. Base cover 3 is a lid that covers the top of the base 26. A shelter structure is assembled on top of the base 26 and base cover 3, and includes stays 1, inside top 2, top cover 4, battery cover 5, and outer housing 6. The stays 1 are individual pieces that together form a cylindrical structure with an opening 32 into the interior. The inside top 2 rests in a groove or lip in the inside upper surface of the stays 1. Top cover 4 is preferably the same molded plastic housing as the base 26, but without the target prey 24 and operating mechanism. Since the base 26 has a battery compartment and cover, the top cover 4 also needs a cover 5 for the battery compartment. Alternatively, the top cover 4 need not be the same as the base 26, in which case the top cover 4 and inside top 2 can be a unified structure without need for a battery cover 5.

The stays 1 support the upper portion of the housing and connects to both the base 26 and the top cover 4. The entire outside of the toy, except the bottom and the openings for the pet and prey, are covered with the outer housing 6, which preferably is constructed in such a manner as to provide a scratching surface for the pet.

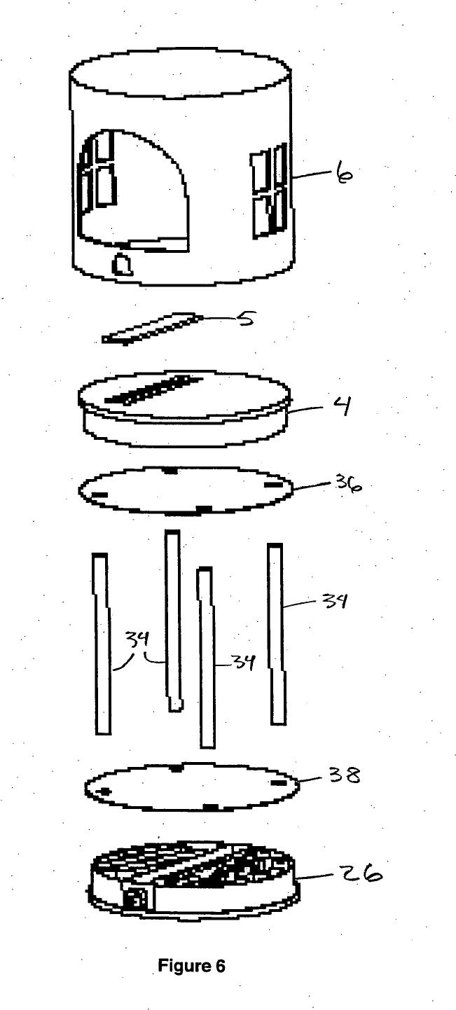

FIG. 6 provides an exploded view of the construction of another embodiment wherein posts 34 are employed to provide support for the top cover 4 and inside top 36. The bottom of the posts 34 are inserted into mating holes in base cover 38. In this or other embodiments, the top could contain another target prey and actuating mechanism, if desired.

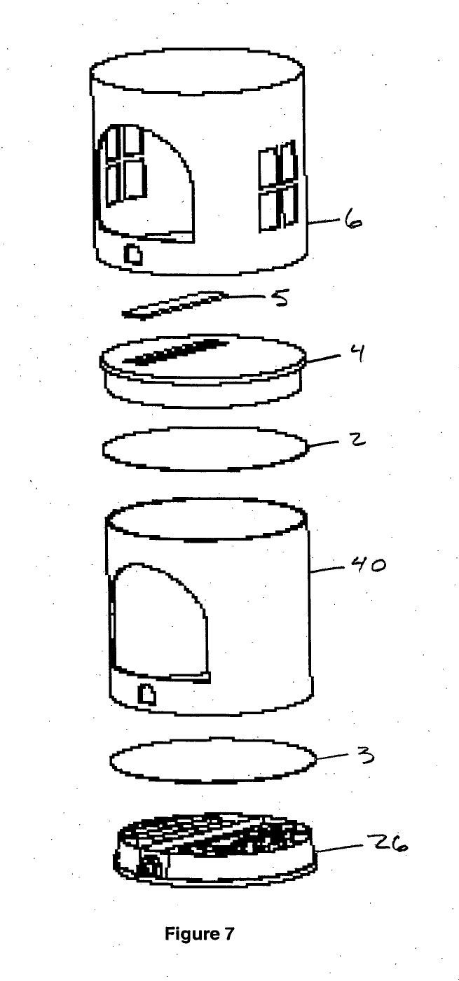

FIG. 7 provides an exploded view of the construction of another embodiment wherein a tube 40 with openings is employed to provide support for the top cover 4 and inside top 2 for the pet house portion of the interactive toy and shelter of the present invention. Preferably, the tube is cardboard or heavy paper.

FIG. 8 shows the target prey 24, which in this embodiment is designed for the head and front paws of a mouse. Target prey 24 is an assembly composed of a mouse design body 18, a mouse head 19, mouse axles 20, mouse wheels 21, and mouse wheel spacers 22. The wheels 21 roll on the axles 20 and allow the whole assembly 24 to roll to expose or retract the mouse head from view. As shown in FIG. 9, the target prey 24 is positioned within a tube that is formed between a mouse hole 13 and a mouse hole bottom 12. The mouse wheel spacers 22 keep the wheels near the inside walls of the body 18. The outside of the mouse body 18 is shaped to match the inside shape of the mouse hole 13 in such a manner that guidance is provided for the target prey assembly 24 as it moves inside the tunnel created by the mouse hole 13 and its bottom 12. A clamping feature 27 allows the mouse assembly to be attached to a drive cable 16 shown in FIG. 9. The mouse head 19 is removable by the pet and can be made of edible material. The feature holding the mouse head 19 has an adjustable holding force. In some embodiments, only part of the mouse head 19 may be edible, such as the nose. The edible portion of the mouse assembly 24 may be replaced automatically from a magazine, not shown, in the base 24 and loaded through top spout 27 from a hopper for food pellets transferable through spout 27 and into magazine or directly to head of mouse for easy re-loading of edible material.

FIG. 9 shows a top, front, side and exploded view of the base assembly 26 of the toy. Batteries 25 and battery cover 5 are installed from the bottom of the base 4. The batteries 25 are connected to a printed circuit board (PCB) assembly 23 by wires. The PCB assembly 23 is in turn connected to a motor 14 by wires. The motor 14 has attached to its output shaft a worm gear 9 that drives a gear 15 that has a pulley attached. The pulley drives a belt 17 which then drives a pulley 11 which has a larger pulley attached. The larger pulley moves a drive cable 16 which is attached to the target prey assembly 24 so as to move the target prey assembly 24 back and forth in a linear motion inside the tunnel. The larger pulley of pulley 11 is of sufficient diameter so that the circumference is greater than the linear distance the mouse assembly 24 can move. In other words, the pulley 11 rotates less than one full revolution. This allows a sensor flag on pulley 11 to engage sensors on the PCB assembly 23 to provide limits for the control electronics of the PCB assembly 23 to stop the motor when the target prey assembly 24 reaches the end of its travel in either direction. A second pulley 11 is used as an idler to support the drive cable 16. Three pulley shafts 10 are fixed to the base 26 to support and allow rotation of the two pulleys 11 and the gear 15. The mouse hole 13 and associated mouse hole bottom 12 provide a tunnel for the target prey assembly 24 to be captured and guided in.

The PCB assembly 23 has a speaker to reproduce sounds such as squeaking, scratching, owner recorded commands used for training purposes, inaudible frequency aural ques responsive to subject to animal hearing, etc. The PCB assembly 23 is attached by wire to a three position switch that allows for selection of modes such as off, remote and display. The PCB assembly has a circuit to provide light to the eyes of the target prey assembly 24 by means of a flexible wire or fiber optic cable. The PCB assembly 23 may have an antenna and associated receiver to receive wireless radio frequency transmissions from a remote control transmitter, the transmitter having a forward and reverse joystick to vary the speed and direction of the mouse assembly 24. The receiver may also contain wireless circuitry for tracking a subject pet's location. Where motion detectors fail to detect or determine a pet's location because the pet is in another room or outside the proximity sensor, a position broadcast or tracking sensor can be mounted on the animal or animal's collar or other attachment to provide a means to determine what kind of aural queue is necessary to attract the animal. A dog may require a inaudible frequency to beacon him to food if they are outside proximity. An animal being trained will respond to a command given or recordings of real prey made for training purposes. These could be used in conjunction with the automatic feeding dispenser in programmable or classical re-enforcement technique training. Although in a preferred embodiment, the food can be dispensed by mechanical manipulation by manual operator actuation, the PCB assembly 23 may also have the typical digital components such as processor, memory, and I/O and software environment to support the programmability character of food dispensation and training.

The preferred materials of construction and the quantities for the various parts are as follows: stave 1—(8×) plastic, wood, paper, metal; inside top 2—(1×) plastic, wood, paper, metal; base cover 3—(1×) plastic, wood, paper, metal; top cover 4 or base 26—(2×) plastic, wood, paper, metal; battery cover 5—(2×) plastic, wood, paper, metal; outer housing 6—(1×) cloth, paper, carpet, plastic; support post 34—(4×) plastic, wood, paper, metal; housing tube 40—(1×) plastic, wood, paper, metal; worm gear 9—(1×) plastic, metal; pulley shaft 10—(3×) plastic, metal; pulley 11—(2×) plastic, metal; mouse hole bottom 12—(1×) plastic, wood, paper, metal; mouse hole 13—(1×) plastic, wood, paper, metal; motor 14—(1×); gear 15—(1×) plastic, metal; drive cable 16—(1×) plastic, wire, rope; drive belt 17—(1×) plastic, wire, rope; mouse body 18—(1×) plastic, wood, paper, metal; mouse head 19—(1×) plastic, wood, paper, metal, food; mouse axle 20—(2×) plastic, metal; mouse wheel 21—(4×) plastic, wood, metal; mouse wheel spacer 22—(2×) plastic, wood, paper, metal; printed circuit board assembly 23—(1×); target prey (mouse) assembly 24 (1×); batteries 25 (4×); base assembly 26 (1× or 2×).

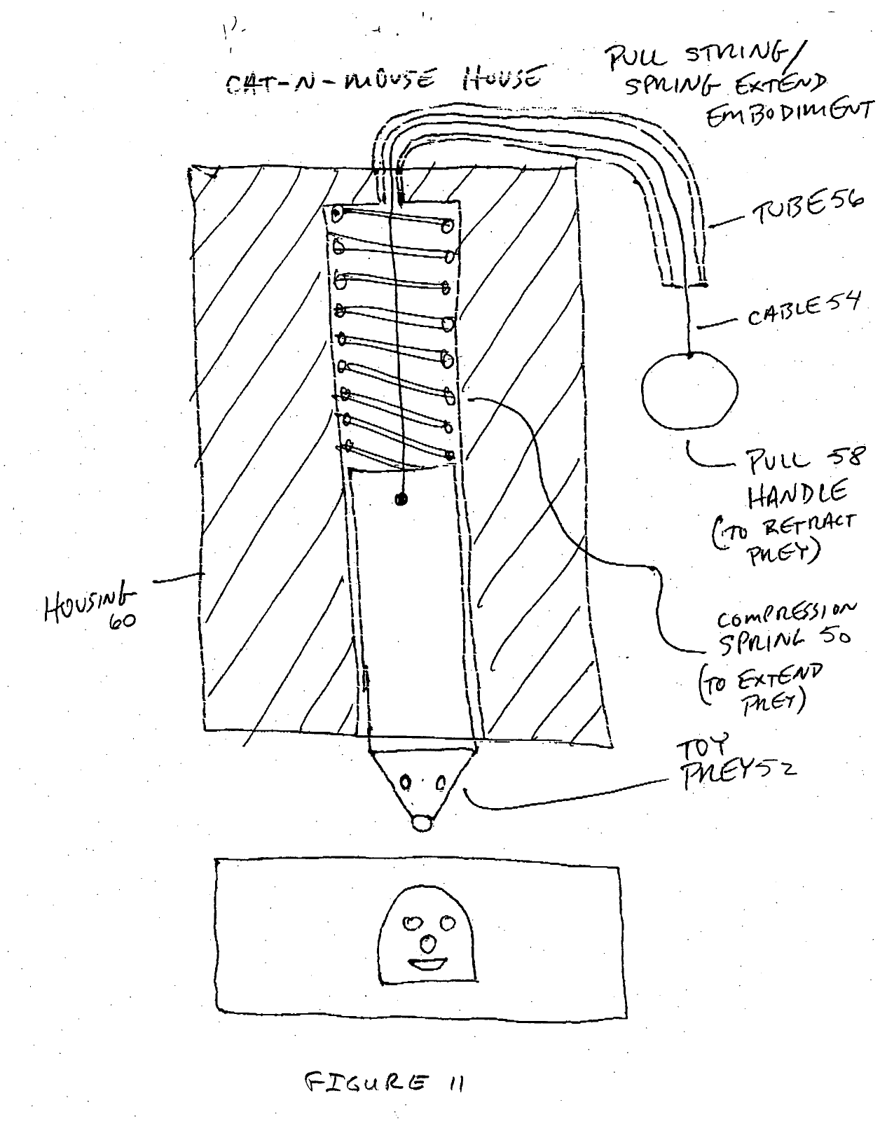

Alternative actuating mechanisms are shown in FIGS. 11-14. These actuating mechanisms can be incorporated into a base unit similar to base 26, with or without the upper housing structure, or can be built as shown. In FIG. 11, the actuating mechanism includes a compression spring 50, toy prey 52, and a cable 54 inside a tube 56 with a pull handle 58. An operator pulls on the handle to compress the spring 50 and retract the toy prey 52 into the housing 60. When the handle is released, the spring 50 extends the toy prey 52 past the end of the housing to expose it to a pet.

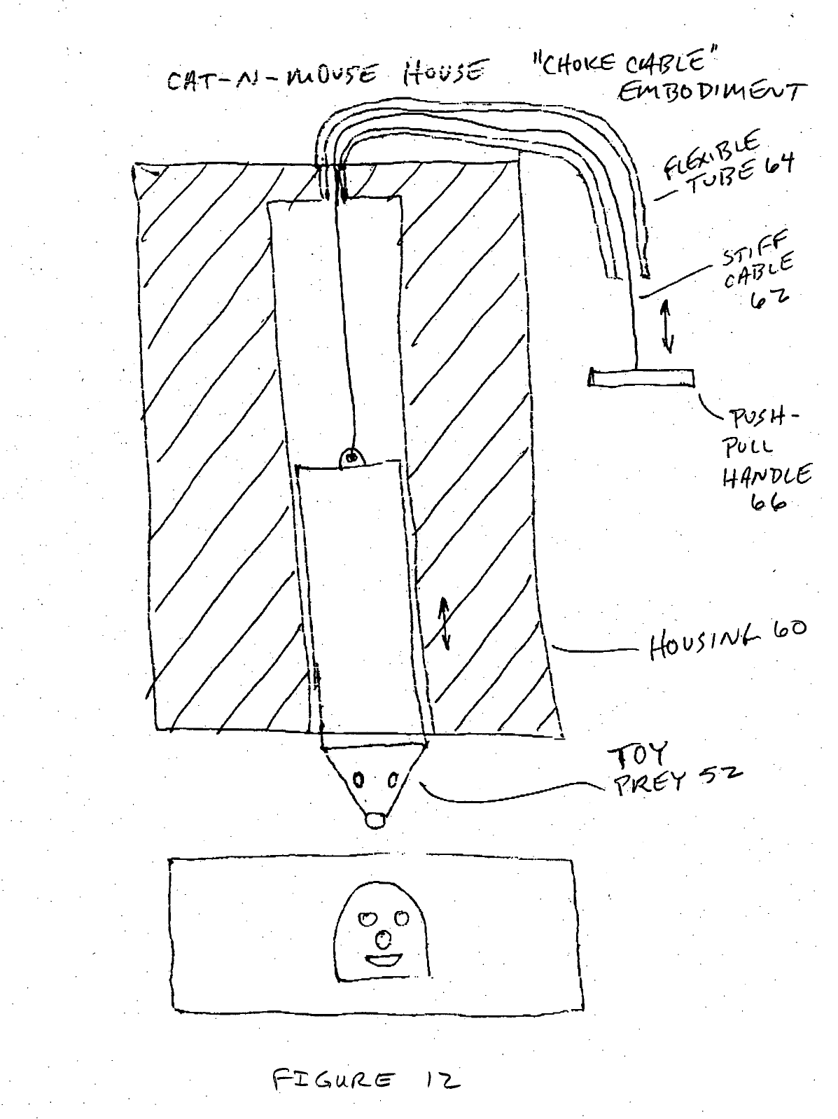

In FIG. 12, a stiff cable 62 inside a flexible tube 64 is used to both extend and retract the toy prey 52. An operator pushes or pulls on a handle 66 to move the cable 62 inside the tube 64, which causes the toy prey 52 to move inside the housing 60.

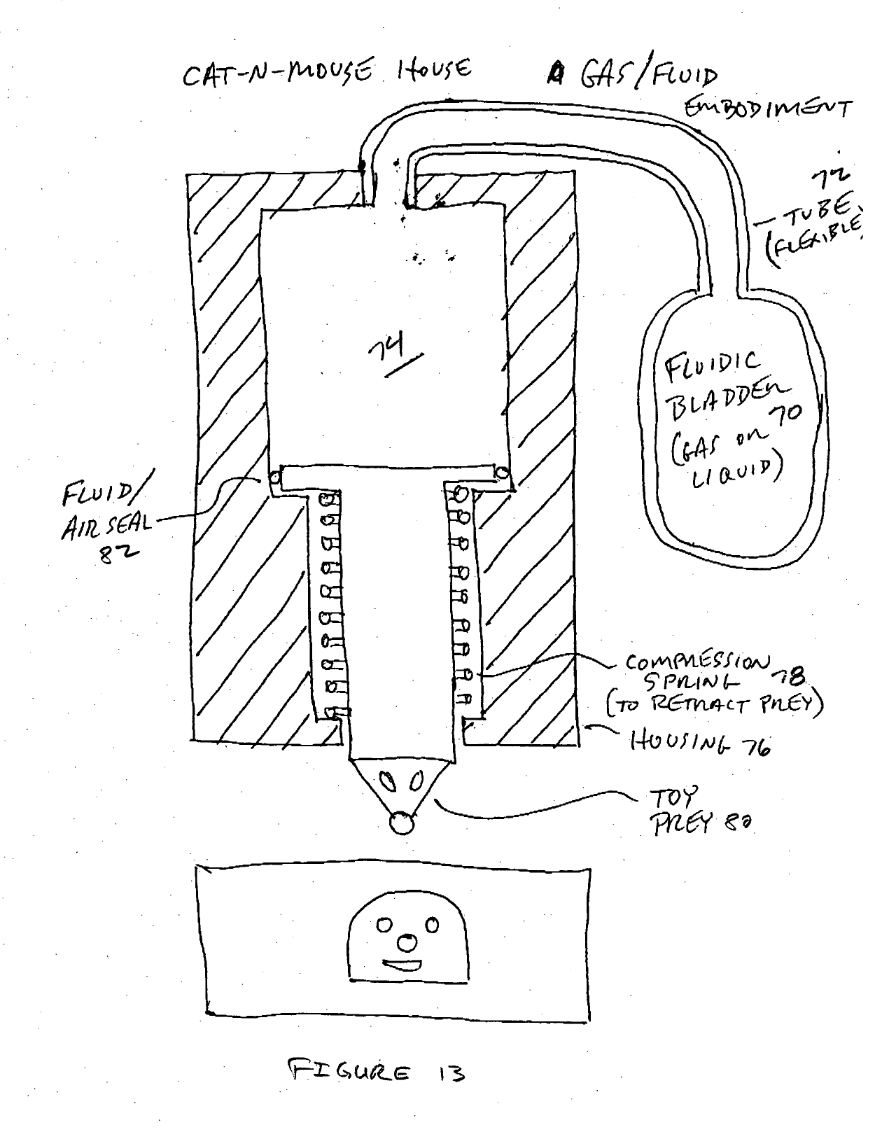

In FIG. 13, the actuating mechanism is provided by a pressurized fluidic bladder 70, tube 72 that connects the bladder to a cylinder 74 in the housing 76, and a compression spring 78. The end of the cylinder 74 formed by the base of the toy prey 80 is sealed with a seal 82. Pressurizing the bladder 70, for example, by squeezing the bladder, compresses the fluid in the cylinder 74 and the compression spring 78 and causes the toy prey 80 to extend past the end of the housing. Releasing the pressure in the bladder 70 and the cylinder 74 enables the compression spring 78 to move the toy prey 80 inside the housing.

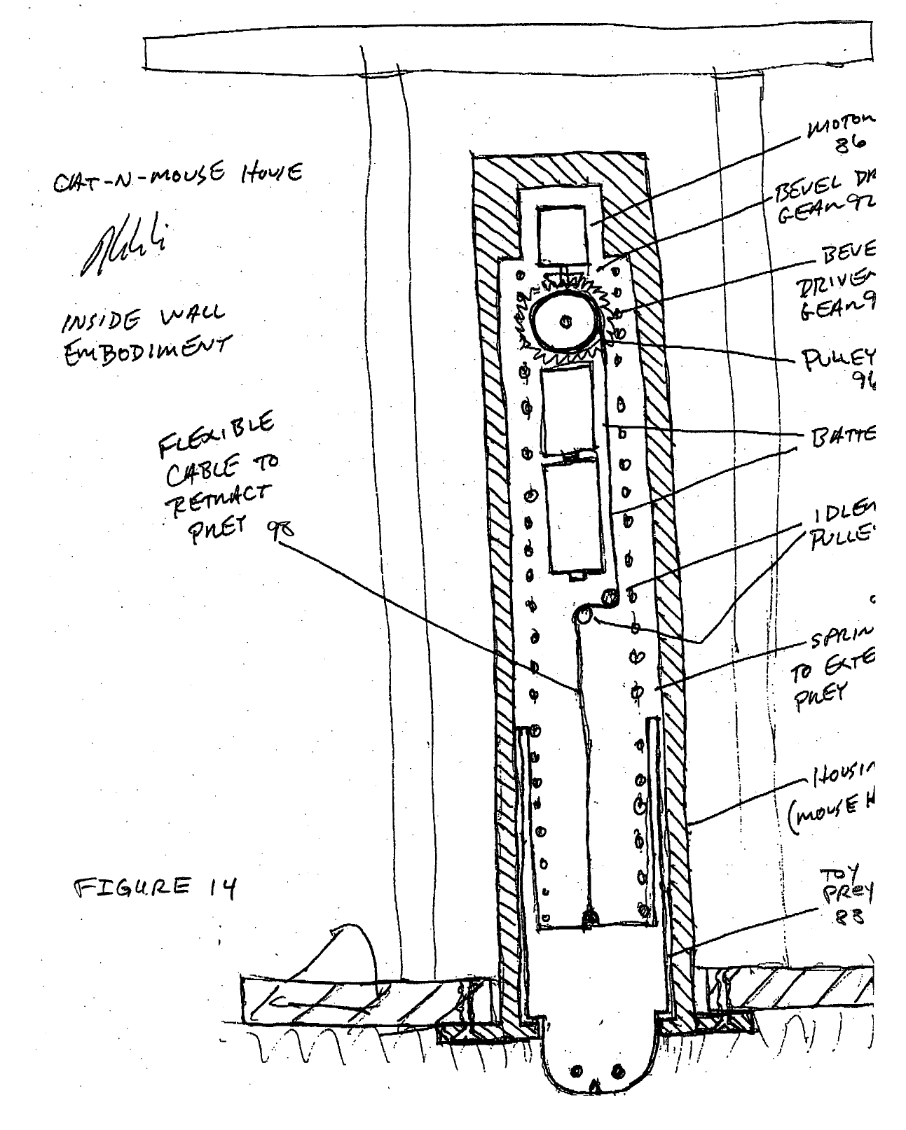

In FIG. 14, an actuating mechanism is provided with a motor 86 to retract the toy prey 88 and a compression spring 90 to extend the toy prey. The motor 86 drives a gear 92, which drives a mating gear 94 and pulley 96. The pulley winds a flexible cable 98 to retract the toy prey 88 when the motor is turned on. When the motor is turned off, the spring 90 extends the toy prey 88 past the end of the housing 100.

FIG. 15 is an exploded perspective outside view of a preferred embodiment of an interactive pet toy, food delivery and shelter according to the present invention. The toy prey object assemblies 1515 and 1521 are shown for the shelter housing top and bottom respectively. The shelter opening 1501 is sufficiently large for the animal(s) to be kept there. The housing contains a port hole 1505 for each prey head 1509, the assembly 1515 fits smartly inside 1517 and behind the port hole 1505. The prey object assembly 1515 contains the prey object body whose prey head 1509 extends and retracts through the port hole 1505. The hole opening 1510 on the prey head 1509 allows food pellets to be dropped into and be positioned as the prey's nose 1507. The food pellets are supplied from the food hopper 1513 via the funnel 1511 upon prey object body and prey head 1509 retraction into the shelter and housing assembly 1503. As in other embodiments shown above, the prey head 1509 can be extended or retracted/reloaded by remote manual manipulation of the cable 1519 or electronically, via typical remote control mechanisms know to those skilled in the art.

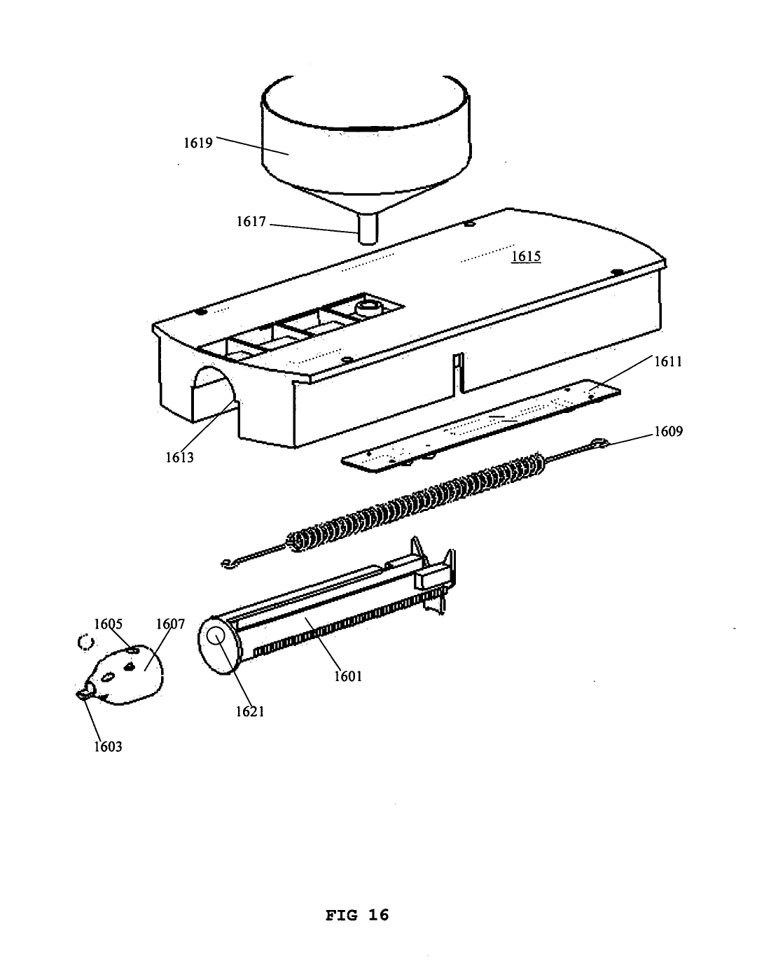

FIG. 16 is an exploded perspective view of an interactive pet toy prey object assembly according to an embodiment of the present invention. The prey object body 1601 is rigidly attached to the prey head 1607 and extended outward by a cable mechanism, manual mode, or motor mechanism, automatic/remote mode. The extension spring 1609 aids in retracting the prey object body 1601 inside the shelter housing for food reloading of the prey head 1607. The food pellets are stored in the hopper 1619 and load through the funnel 1617 into the prey head port 1605 or alternative orifice 1621 via the prey body channel 1601. The food pellet is moved to the prey head nose 1603 where it awaits for feeding. The prey object body 1601 and prey head 1607 mechanism fit inside the assembly housing 1615 through a collar 1613.

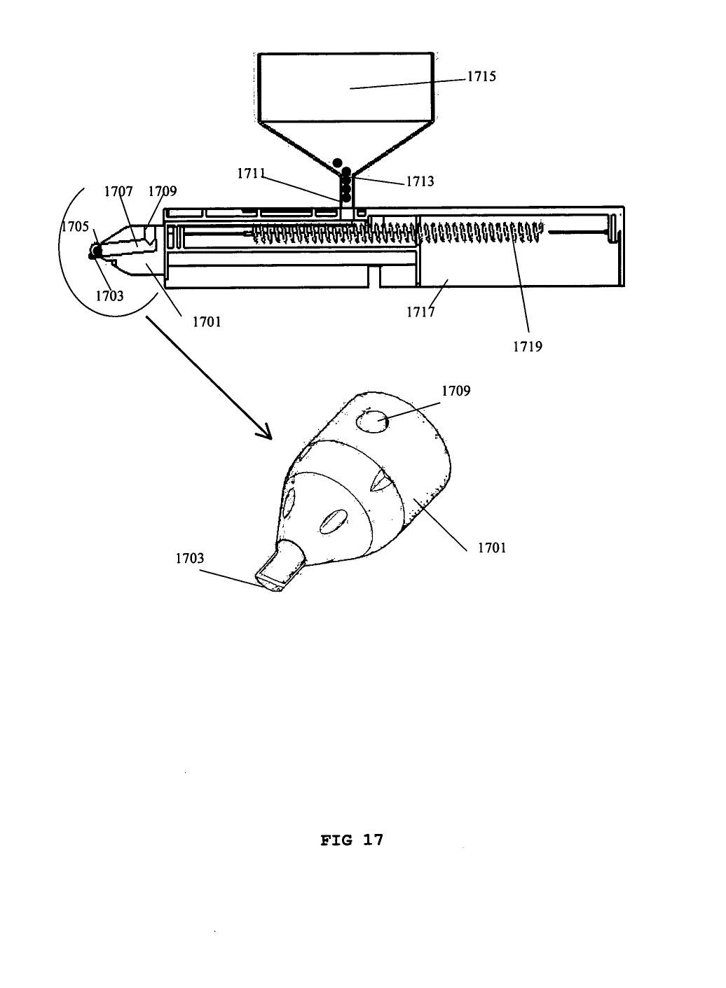

FIG. 17 is a cross section side view of an interactive pet toy prey object assembly with food feeder and delivery mechanism according an embodiment of the present invention.

The prey object body 1717 is attached to the prey head 1701 and extended outward by a cable mechanism, manual mode, or motor mechanism, automatic/remote mode. The extension spring 1719 aids in retracting the prey body 1717 inside the shelter housing for food reloading into the prey head 1701 via the top opening 1709. The food pellets 1713 are stored in the hopper 1715 and load through the funnel 1711 where they are held until the prey is retracted, pellets are loaded via a prey head top opening 1709 in communication with the prey nose conduit 1707. The food pellet is moved to the prey head nose 1703 where it awaits a prey object body 1717 extension outward for animal feeding. The prey head nose 1703 contains a lip to support the pellet from falling on its own, requiring some effort by an animal.

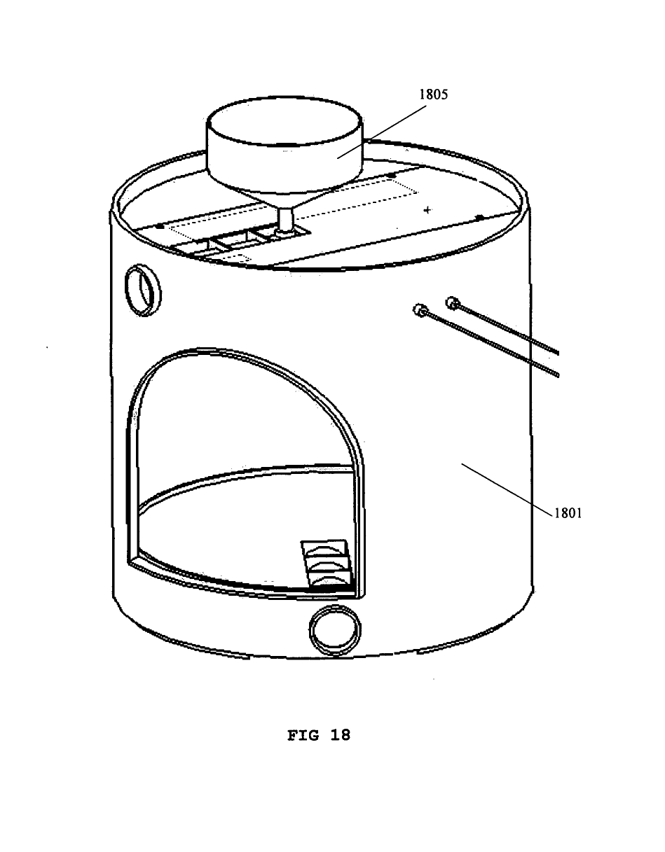

FIG. 18 is a perspective view of an interactive pet structure with feed hopper according an embodiment of the present invention. The feed hopper 1805 is shown using gravity feed. The food hopper 1805 is removable, upon a prey assembly magazine load, and can be covered by a more appealing top with other utility.

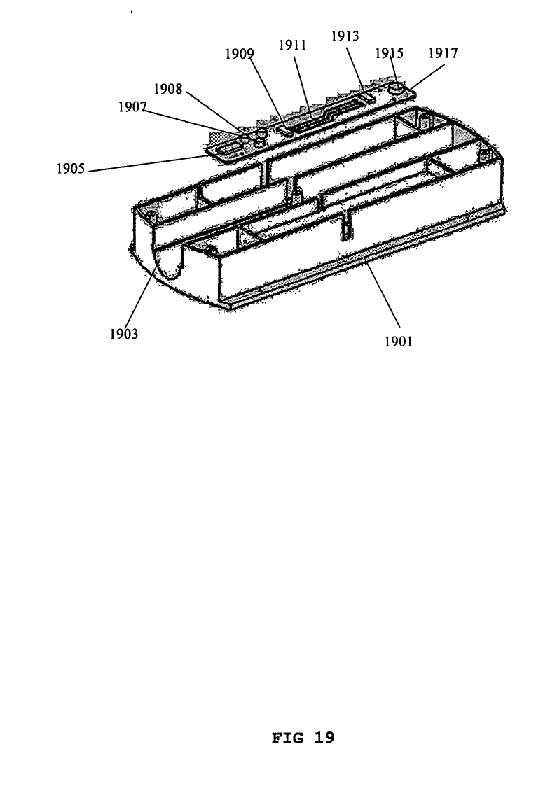

FIG. 19 is a perspective view of the PCB and electronics assembly according an embodiment of the present invention. The PCB and electronics assembly 1917 fits inside the prey object assembly 1901. The prey object collar 1903 is shown for orientation purposes. The PCB and electronics assembly 1917 holds the processor 1905, RAM 1907 and ROM 1908 memory, I/O controller 1909, wireless antenna and interface 1913, power and conditioning circuits 1911, audio amp 1915 and ancillary analog and digital circuits. A software environment is used to generate the programmable features into firmware, which is burned into the RAM 1907 and ROM 1908. The processor 1905 accesses the memory 1907 1908 for executable instructions as well as I/O controller 1909 access for external events from inbound sensor traffic from animals via wireless interface 1913 and out bound audio 1915 as well as outbound wireless network traffic.

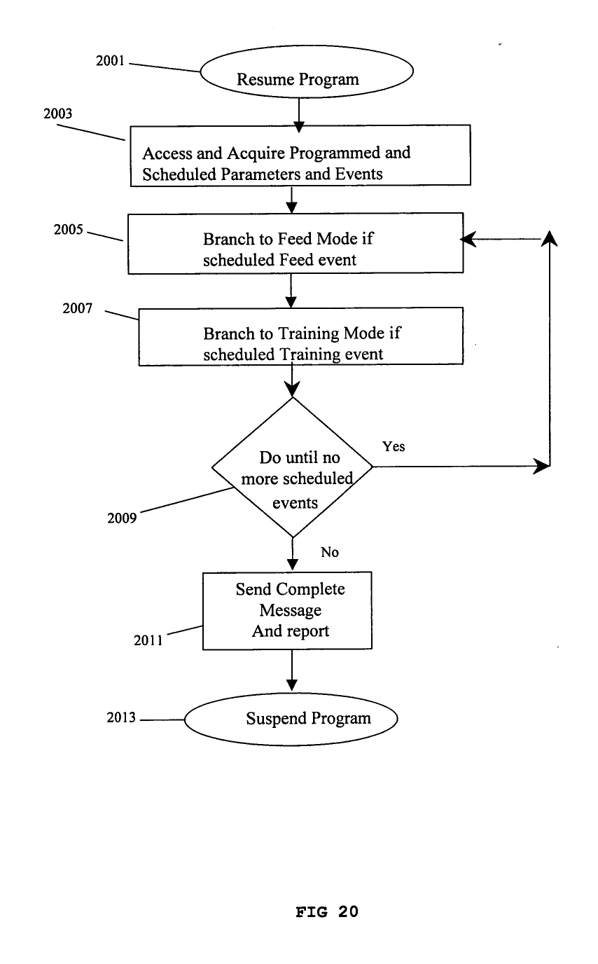

FIG. 20 illustrates a high level cycle of operation for the electronic programmable automation of feeding and training for a selected animal in accordance with an embodiment of the present invention. A computer device executing an exemplar program enters an execution loop upon being engaged in Program Mode at Resume Program 2001 and accesses and acquires 2003 selected program parameters such as scheduled events, feed times, feeding quantities, animals to be fed and trained, pre-recorded commands, selected audio and aural ques, etc. The program execution then steps to Feed Mode 2005 wherein it executes any scheduled feed events and upon returning steps to Training Mode 2007 where it executes all scheduled training events. Upon returning from Training Mode 2007 the program execution continues to loop 2009 until event exhaustion wherein the program stores and sends a message reporting 2011 any programmed messages, progress, food or training results, etc. This ends the Programmed Mode cycle 2013 wherein the execution thread suspends program and returns to the mode select option level.

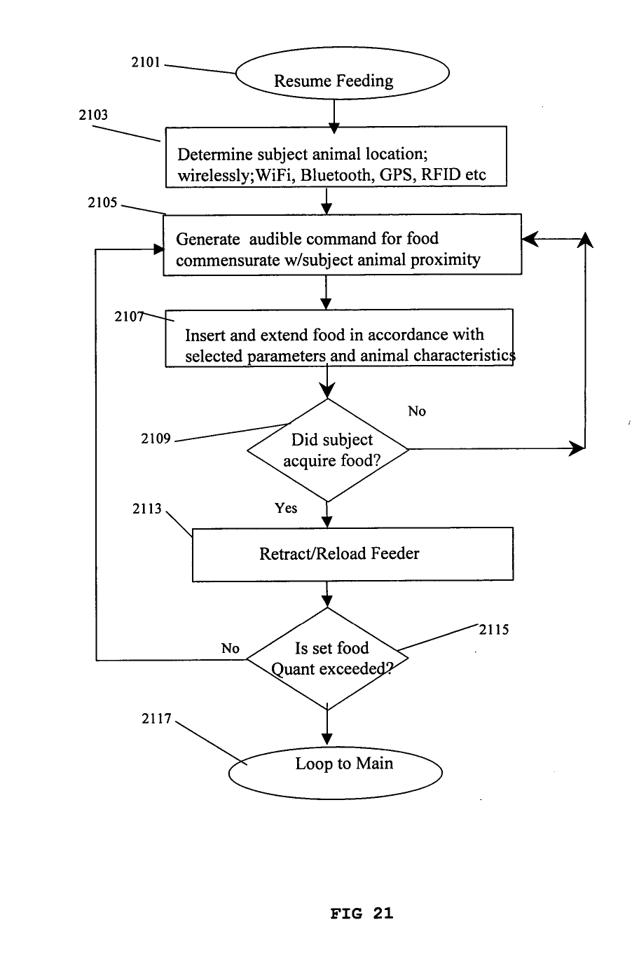

FIG. 21 illustrates a high level cycle of operation for the programmed automatic feeding of a selected animal in accordance with an embodiment of the present invention. The routine begins at Resume Feeding 2101, steps to determine subject animal location 2103 from wireless sensor on subjects collar or other attachment, using any of the wireless protocols such as WiFi, GPS, Bluetooth, IEEE 802.x, and corresponding hardware components performing these functions, calculate proximity from prey object and generate an audible command 205 for food, sound pressure level commensurate with selected animal proximity. The food pellet can be inserted and extended 2107 from the prey object in accordance with the pre-selected or programmed parameters scheduling feeding times and quantities or training regime cycles. The animal distance if close with prey object for reasonable duration can signal if food was acquired 2109. If not acquired, then branch back to beacon the animal 2105 for the appropriate determined distance. Once food is acquired, the prey object is retracted and reloaded 2113 for the next round of feeding. When the feed selected quanta is reached 2115, the thread of execution will branch back to the main loop 2117.

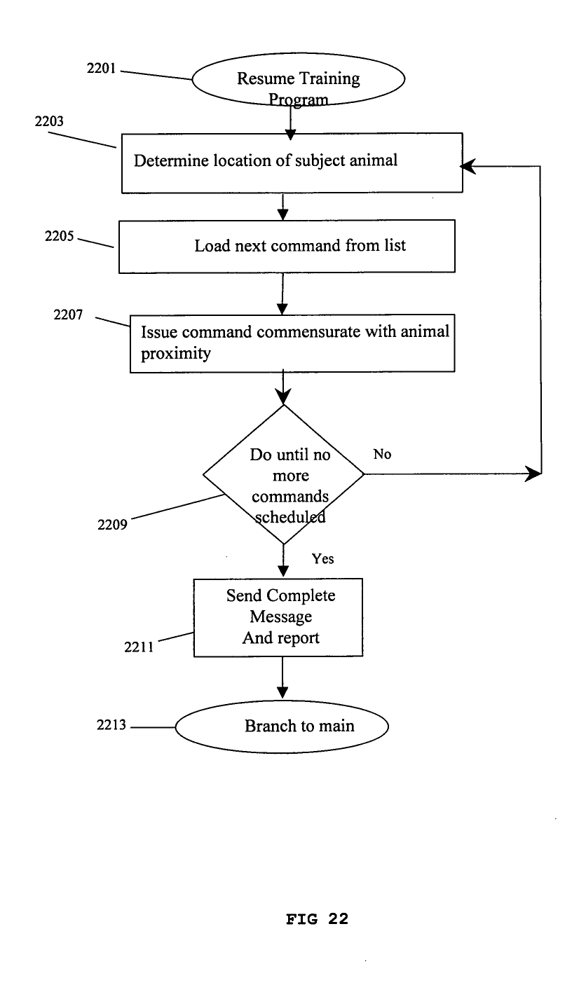

FIG. 22 illustrates a high level cycle of operation for the programmed automatic training of a selected animal in accordance with an embodiment of the present invention. The routine begins execution at Resume Training 2201 wherein it steps to determine the location of the subject selected animal 2203 by reading the animals location from a wireless sensor attached to the animal and calculating the distance to the known prey object position. Execution then steps to read any commands to be issued to the selected animal from the program training list 2205 of commands loaded at program mode access step in the main loop. The command is then issued commensurate with animal proximity 2207 and type of command, which could be pre-recorded owner, standard set of pre-recorded commands, non-audible high frequency animal only sounds, or other types, all of which are programmably adjusted for volume and frequency to accommodate distance from prey object to animal. The program then continues to loop 2209 until all commands on the command list are exhausted, at which point a message report is sent 2211 to the selected output 2213 and the execution thread returns 2215 to the calling routine.

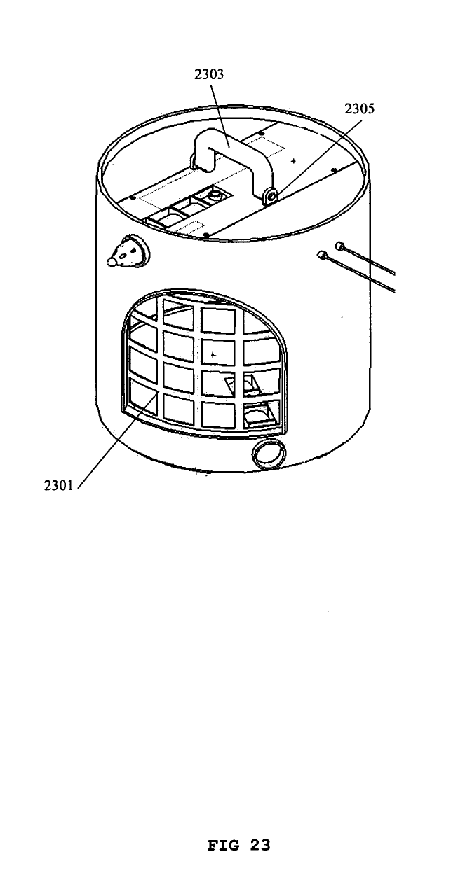

FIG. 23 is a perspective view of a preferred embodiment of an interactive pet toy, food delivery system and shelter illustrating the portability features in accordance with an embodiment of the present invention. In order to convert the shelter housing into a porting container, a door 2301 will cover the shelter opening with a rigid locking mechanism. A handle 2303 is pivotal from hinges 2305 rigidly secured to and designed to support the load from the shelter weight and animal.

Although the invention has been described briefly with reference to specific exemplary embodiments thereof, it will be evident that various modifications and changes may be made thereto without departing from the broader spirit and scope of the invention as set forth in the appended claims. The specification and drawings are, accordingly, to be regarded in an illustrative rather than a restrictive sense

From the above description, it will be apparent that the invention disclosed herein provides a novel and advantageous interactive toy, food delivery, training and shelter for pets specifically and animals in general. The foregoing discussion discloses and describes merely exemplary methods and embodiments of the present invention. As will be understood by those familiar with the art, the invention may be embodied in other specific forms without departing from the spirit or essential characteristics thereof.

What is claimed is:

1. A combined animal entertainment, food delivery and training system comprising:
a housing with one or more artificial prey objects capable of extending out from, and retracting into the housing;
a means to mechanically manipulate the prey object extension and retraction, and
a means to dispense food coupled to the prey object wherein food is dispensed when the prey object is exposed and reloaded when prey object is retracted,
whereby an animal can be entertained or trained through the use of an artificial prey object coupled with food dispensation.

2. An animal entertainment, food delivery and training system as in claim 1 further comprising an electrical power source and electromechanical means to manipulate the prey object remotely.

3. An animal entertainment, food delivery and training system as in claim 2 further comprising an electronic wireless signal means to locate a selected animal with a mounted wireless sensor device.

4. An animal entertainment, food delivery and training system as in claim 2 further comprising electronic media and electronic components with processor capable of executing programmed commands for issuing aural commands or inaudible queues to the selected animal.

5. An animal entertainment, food delivery and training system as in claim 1 further comprising an artificial prey object with animal removable edible component.

6. An animal entertainment, food delivery and training system as in claim 2 further comprising electronic media and electronic components with processor capable of executing programmed commands for food delivery to the animal.

7. An animal entertainment, food delivery and training system as in claim 6 further comprising electronic means of monitoring, storing, and reporting a selected animals food intake and response behavior by wireless transmission to Internet coupled device.

8. A combination pet toy, food delivery and shelter assembly comprising: an enclosed housing having top, bottom and side surfaces and an aperture for pet entry and at least one movable furtive pet toy which moves forward and backward in a housing to alternately expose and the movable furtive pet toy.

9. The combination pet toy, food delivery and shelter assembly of claim 8 wherein integrated aperture closure and porting mechanism facilitate transporting an animal.

10. The combination pet toy and food delivery and shelter assembly of claim 8 wherein the movable furtive pet toy is operated remotely.

11. The combination pet toy and food delivery and shelter assembly of claim 8 further comprising a mechanically operated movable furtive pet toy wherein the movable furtive pet toy mechanism is activated by animal motion proximate to the combination pet toy and food delivery and shelter assembly.

12. The combination pet toy and food delivery and shelter assembly of claim 8 wherein the movable furtive pet toy is an olfactory attractant.

13. The combination pet toy and food delivery and shelter assembly of claim 8 wherein the movable furtive pet toy has a removable and edible component.

14. The movable furtive pet toy and food delivery of claim 13 wherein the removable edible treat is manually replaced after treat capture by the pet.

15. The movable furtive pet toy and food delivery of claim 13 wherein the removable edible treat is automatically replaced when removed by the pet.

16. The movable furtive pet toy and food delivery of claim 13 wherein the force required to remove the edible treat can be adjusted.

17. The mechanically operated movable furtive pet toy and food delivery of claim 8 wherein the movable furtive pet toy mechanism is activated by wire, infrared, radio, or remote control.

18. The mechanically operated movable furtive pet toy and food delivery of claim 8 wherein the movable furtive pet toy and food delivery has a speaker to reproduce sounds such as squeaking, scratching, etc.

19. The combination pet toy, food delivery and shelter assembly of claim 8 wherein the movable furtive pet toy has lighted eyes that “blink” in a natural manner.

20. The pet toy and food delivery assembly of claim 2 wherein the movable furtive pet toy has a selectable off, remote, and display mode.
